(19) United States
(12) Patent Application Publication
(10) Pub. No.: US 2014/0318392 A1
(43) Pub. Date: Oct. 30, 2014

(54) LABORATORY HEAT PRESS

(71) Applicants: Pavol Sajgalik, Bratislava (SK); Miroslav Hnatko, Bratislava (SK); Zdeno Pábek, Oscadnica (SK)

(72) Inventors: Pavol Sajgalik, Bratislava (SK); Miroslav Hnatko, Bratislava (SK); Zdeno Pábek, Oscadnica (SK)

(21) Appl. No.: 14/365,587

(22) PCT Filed: Dec. 13, 2011
(86) PCT No.: PCT/SK2011/000024

§ 371 Date: Jun. 13, 2014

(51) Int. Cl. B30B 15/34; B30B 11/02

(52) U.S. Cl. CPC B30B 15/34; B30B 11/027
USPC 100/315

(57) ABSTRACT

Laboratory heat press consists of furnace part equipped with dilatometer which is placed beneath removable double-acting pneumatic cylinder anchored on four shafts, of power supply and of computer which regulates process and collects data, while in the working space is situated graphite press die with sample, which is placed on sliding piston holder and the device is equipped with control electronics. Heating equipment is graphite element, and around the element are situated graphite shields made from solid graphite and graphite wool insulation. Outer shell of furnace and both flanges are water cooled. Flanges are equipped with holes for thrust pistons and the furnace shell contains hole for connecting the vacuum pump and hole for installation of the pyrometer. Graphite pressing die with sample is equipped with pistons, which are influenced by power from double-acting pneumatic cylinder, while on the both graphite pistons are graphite radiative rings and between them is graphite wool.

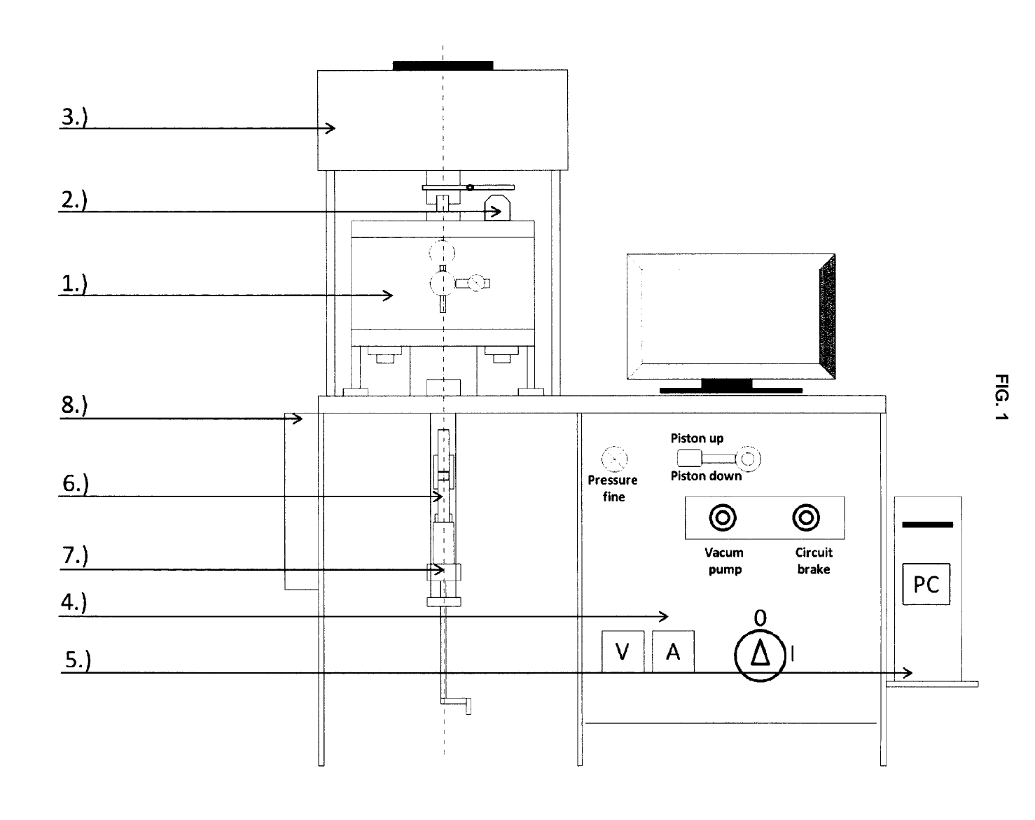

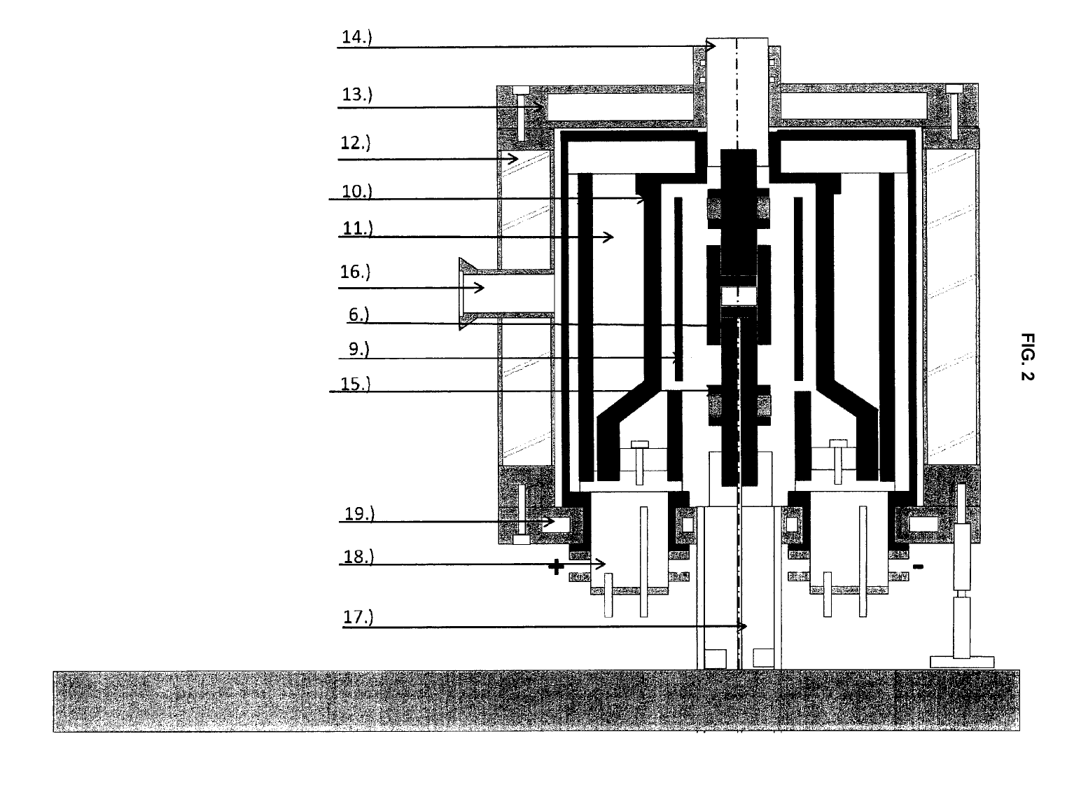

### FIELD OF THE APPLICATION

Technical solution is related to the equipment belonging to the laboratory devices used in basic or applied research in the field of construction ceramic materials based on nitrides, carbides, borides and oxides.

### BACKGROUND TO THE INVENTION

Preparation of dense ceramic materials for the purposes of research and development was till now solved by devices that are highly energy demanding and the whole sintering process (heating, hold-off, cooling) is also time-demanding. As a consequence, the price of the component prepared by use of these devices is increasing. Heat presses, which are currently used in this field have disadvantages in dimensions of the devices and therefore requirements for space, and in high operation requirements.

Device described in this technical solution, enables preparation of samples in a quick and low-cost manner, while such devices are currently not available.

### BRIEF SUMMARY

Disadvantages of currently used devices are solved by Laboratory Heat Press, and the main advantage of the technical invention is that ceramic samples with high density can be prepared on this press in considerably shorter time and at much lower costs.

Laboratory Heat Press according to this technical solution consists of furnace furnished with dilatometer whereby the furnace is situated beneath removable double-acting pneumatic cylinder anchored on four shafts, the power supply and the computer which is responsible for the process regulation and data collection, while in the workspace of the device is located a graphite die with the sample placed on adjustable piston holder and the device is equipped with electronic control.

Around heating graphite element are graphite shields made from solid graphite and graphite wool insulation, the furnace outer shell and both flanges are water cooled. Flanges are equipped with holes for thrust pistons, furnace shell contains one hole through which is connected the vacuum pump, and one hole for installation of pyrometer.

Graphite pressing die with the sample has pistons which are influenced by power of double-acting pneumatic cylinder. There are graphite radiation rings on both graphite pistons and graphite wool is between the rings.

The device is equipped with dilatometer, analogue inductive position sensor which monitors shrinkage of the sample during sintering.

Thermocouple of type C which is placed in the lower piston under the sample is used for measuring temperature. Device according this solution is supplied by power block with phase interface, while primary part of the block is controlled by computer.

### BRIEF DESCRIPTION OF THE DRAWINGS

FIG. No 1 shows the layout of the whole heat press and FIG. No 2 shows scheme of furnace part together with pressing die with sample.

### DETAILED DESCRIPTION OF THE INVENTION

Constructed laboratory heat press allows preparation of dense ceramic materials by sintering the powders under high temperature (up to 2100° C.) and under axial pressure of up to 40 MPa in inert atmosphere (Ar, N₂) or in vacuum.

In principle, heat pressing is simple technology for production of ceramic components, which is based on heating the pressing die of the piston-cylinder type to sintering temperature. Pressure is usually applied hydraulically. The required temperature is achieved either by indirect heating of the pressing die by outer resistance furnace, or in case of graphite dies by direct heating from resistance furnace or by its induction heating.

The device according to this solution consists of the furnace part 1 placed below the removable double-acting pneumatic cylinder 3 with large diameter (Φ=200 mm), dilatometer 2 power supply 4 and PC 5 (regulation and data collection).

The furnace shell 12 and pistons 13 are water cooled. Both flanges have holes for thrust pistons. Upper thrust piston 14 is made of special refractory steel and is water cooled similar to pistons. Lower, static piston is divided into 2 parts, while his upper part 17 is made from special refractory steel and the lower part 18 is water cooled.

Furnace shell has hole for connecting the vacuum pump 16 and the whole furnace workspace can be hermetic sealed. Furnace construction allows for achieving of high vacuum or moderate overpressure of inert gas (up to 0,15 MPa).

Specially constructed graphite element 9 is used as heating element which enables quick start-up of the temperature (50° C./min., up to 1500° C.) and sufficiently long zone with homogenous temperature. Equipment holding the element is part of power supply 18, which is made of highly conductive material and is water cooled. Around heating element 9 are situated the graphite shields made from solid graphite 10 and insulation from special graphite wool 11. Insulation secures protection of the outer shell 12 together with upper flange 13 and lower flange 19.

Graphite pressing die 6 with sample (Φ_{max.}=20 mm and height 10 mm) and graphite pistons are placed in the working place, while pistons are operated by power from double-acting pneumatic cylinder 3. The role of radiative rings 15 is to protect metal parts (upper and lower pressure piston) from direct heat radiation from the heating element. The device is equipped with analogue inductive position sensor which allows monitoring of sample shrinkage during sintering. Temperature is measured by type C thermocouple which is placed in the configuration of lower pistons. The thermocouple is placed close bellow the sample, and is protected by graphite platter. This enables accurate measurement of real temperature in the sample. Cold ends of the thermocouple are going out of the bottom part of the lower thrust piston. The device is supplied from power block with phase interface, while primary part of the interface is controlled by PC in LabWiev environment. Samples with diameter (Φ_{max.}=20 mm and height 10 mm are suitable for total characterization of prepared material (functional characteristics, mechanical characteristics, chemical and phase composition), which is inevitable proposition in the field of material research.

### INDUSTRIAL APPLICABILITY

Technique of heat pressing is currently used in the field of new construction materials research, but also in the industrial production of dense ceramic platters with various dimensions. Material base for the research and development of ceramic materials includes mainly carbides (SiC, WC, TiC, NbC and others), nitrides (Si₃N₄, BN, SiAlON, TiN, AlN and others), borides (TiB₂, ZrB₂, HfB₂, LaB₆ and others), oxides (Al₂O₃, ZrO₂, TiO₂, Y₂O₃ and others) and their mixtures. Ceramics based on these materials are characterized by solid strength also in high temperatures, by hardness, by high resistance to wear, chemical stability in aggressive environment, low friction coefficient and low density of the material.

Laboratory Heat Press according to this solution allows for preparation of dense ceramic materials by sintering of powders under influence of temperature (up to 2100° C.) and axial pressure up to 40 MPa in inert atmosphere (Ar, N₂), or in vacuum. Such set of material characteristics indicates possibility of low and high-temperature applications in engineering, in metallurgy and foundry industries, in automotive industry, energetics, chemistry, robotics, medicine and also in aeronautics.

1. Laboratory heat press characterized by the fact that device consists of furnace (1) equipped with dilatometer (2) which is situated beneath removable double-acting pneumatic cylinder (3) anchored on four shafts, of power supply (4) and of computer (5) which regulates process and collects data, while in the working space is located graphite press die (6) with sample, which is placed on sliding piston holder (7) and the device is equipped with control electronics (8).

2. Laboratory heat press according to claim 1), characterized by the fact that furnace (1) contains heating equipment, which is graphite element (9) and around the element are situated graphite shields made from solid graphite (10) and insulation from graphite wool (11), furnace outer shell (12), upper flange (13) and lower flange (19) which are water cooled and flanges are equipped by holes for thrust pistons (14,17) and the furnace shell contains hole for connecting of vacuum pump (16) and hole for installation of pyrometer.

3. Laboratory heat press according to the claim 1), characterized by the fact that graphite pressing die (6) with sample is equipped with pistons, which are influenced by power from double-acting pneumatic cylinder (3), while on both pistons are graphite radiative rings (15) and between them is graphite wool (11).

4. Laboratory heat press according to the claim 1), characterized by the fact that the device is equipped with dilatometer (2) which is an analogue inductive position sensor which allows monitoring of sample shrinkage during the process of sintering.

5. Laboratory heat press according to the claim 1), characterized by the fact that temperature is measured by type C thermocouple which is placed in the lower piston (17) bellow the sample.

6. Laboratory heat press according to the claim 1), characterized by the fact that device is supplied from the power block with phase interface, while primary part of the interface is controlled by computer (5).
